(19) United States
(12) Patent Application Publication
(10) Pub. No.: US 2022/0187693 A1
(43) Pub. Date: Jun. 16, 2022

(54) LENS FOCUS ADJUSTMENT ASSEMBLY AND PROJECTOR

(71) Applicant: IVIEW DISPLAYS (SHENZHEN) COMPANY LTD., Shenzhen (CN)

(72) Inventors: Liang Mei, Shenzhen (CN); Mingnei Ding, Shenzhen (CN); Weizhan Zhu, Shenzhen (CN); Steve Yeung, Hong Kong (CN); Zhiqiang Gao, Hong Kong (CN)

(21) Appl. No.: 17/543,772

(22) Filed: Dec. 7, 2021

Related U.S. Application Data
(63) Continuation of application No. PCT/CN2021/079766, filed on Mar. 9, 2021.

(30) Foreign Application Priority Data
Dec. 16, 2020 (CN) 202011487348.X

(51) Int. Cl. G03B 21/14; G02B 7/04

(52) U.S. Cl. CPC G03B 21/142; G02B 7/04

(57) ABSTRACT

A lens focus adjustment assembly and a projector are provided. The focus adjustment assembly includes: a barrel, including a barrel body and a limiting structure, the barrel body defining a receiving space, the barrel body being provided with a channel; a focus adjustment ring, sleeved onto the barrel body and provided with a groove; and a motion assembly, including a support member and a mating member, wherein the support member is configured to fix a lens and positioned in the receiving space, and the mating member extends from the support member and runs through the channel and mates with the groove. When the focus adjustment ring rotates about the barrel body, the groove mates with the mating member and drives the mating member to move back and forth along the channel, and the mating member meanwhile drives the support member to move along the axial line.

### CROSS-REFERENCE TO RELATED APPLICATIONS

This application is a continuation-application of International (PCT) Patent Application No. PCT/CN2021/079766, filed on Mar. 9, 2021, which claims priority to Chinese Patent Application No. 202011487348.X, filed with the National Intellectual Property Administration of China on Dec. 16, 2020, and entitled “LENS FOCUS ADJUSTMENT ASSEMBLY AND PROJECTOR”, the entire contents of which are incorporated herein by reference.

### TECHNICAL FIELD

The present disclosure relates to the technical field of projectors, and in particular, relates to a lens focus adjustment assembly and a projector.

### BACKGROUND

A projecting machine is also called a projector and is a device capable of projecting images or videos onto a canvas. The projector may be connected to a computer, a DV, and the like through different interfaces to play corresponding video signals.

The projector is widely used in scenarios of homes, offices, schools, and recreation places. With the vigorous development of the projection industry, projectors have been applied to the daily lives of the general public, and various projectors may be seen everywhere around. With the rapid development of the industry, projection technology has also been continuously innovated, and a variety of new applications have also emerged.

A micro-projector is a new projection product developed in recent years that uses an LED or laser as a light source and uses an LCOS or DMD as a display chip, and has low power consumption, small size, low price, and increasingly large market scale. In different usage scenarios, the distances between the projection device and a wall or a canvas onto which the projected image is projected are also different. In order to make the projected picture clearer, generally, a focal length of the lens is adjusted accordingly. Therefore, most projection devices have a corresponding focus adjustment module or structure for adjusting the focal length of the lens. Generally, the focus adjustment module is divided into two parts: a fixed module and a movable module (the movable module may be a single lens or a combination of multiple optical elements). The lens of the fixed module is not allowed to move or rotate, such that the focal length is adjusted by movement of the movable module along an optical axis direction.

In the micro-projector, due to the limitation of the structural size, the size of the optical engine machine is very small, such that more mechanical parts may not be accommodated for the focusing design of the lens. However, in most cases, it is necessary to move one or a group of lenses or the entire lens to compensate for the tolerance of the optical system. This causes difficulties to the design of the lens, especially in the design of the micro-optical machine.

### SUMMARY

An embodiment of the present disclosure provides a lens focus adjustment assembly. The focus adjustment assembly includes: a barrel, including a barrel body and a limiting structure, wherein the barrel body defines a receiving space, and the barrel body is provided with a channel; a focus adjustment ring, sleeved onto the barrel body and rotatable about the barrel body, wherein the focus adjustment ring is provided with a groove disposed along a helix, and the limiting structure prevents the focus adjustment ring from moving along an axial line of the barrel body; and a motion assembly, including a support member and a mating member, wherein the support member is configured to fix a lens and positioned in the receiving space, and the mating member extends from the support member and runs through the channel and mates with the groove. When the focus adjustment ring rotates about the barrel body, the groove mates with the mating member and drives the mating member to move back and forth along the channel, and the mating member meanwhile drives the support member to move along the axial line of the barrel body in the receiving space.

Another embodiment of the present disclosure provides a projector. The projector includes a lens focus adjustment assembly. The focus adjustment assembly includes: a barrel, including a barrel body and a limiting structure, wherein the barrel body defines a receiving space, and the barrel body is provided with a channel; a focus adjustment ring, sleeved onto the barrel body and rotatable about the barrel body, wherein the focus adjustment ring is provided with a groove disposed along a helix, and the limiting structure prevents the focus adjustment ring from moving along an axial line of the barrel body; and a motion assembly, including a support member and a mating member, wherein the support member is configured to fix a lens and positioned in the receiving space, and the mating member extends from the support member and runs through the channel and mates with the groove. When the focus adjustment ring rotates about the barrel body, the groove mates with the mating member and drives the mating member to move back and forth along the channel, and the mating member meanwhile drives the support member to move along the axial line of the barrel body in the receiving space.

### BRIEF DESCRIPTION OF THE DRAWINGS

One or more embodiments are illustrated by way of example, and not by limitation, in the figures of the accompanying drawings, wherein components having the same reference numeral designations represent like components throughout. The drawings are not to scale, unless otherwise disclosed.

FIG. 1 is a schematic perspective view of a lens focus adjustment assembly according to an embodiment of the present disclosure.

FIG. 2 is a schematic exploded view of the lens focus adjustment assembly in FIG. 1.

FIG. 3 is a schematic sectional view of the lens focus adjustment assembly in FIG. 1.

### DETAILED DESCRIPTION

For better understanding of the present disclosure, the present disclosure is described in detail with reference to attached drawings and specific embodiments. It should be noted that, when an element is defined as “being secured or fixed to/mounted to” another element, the element may be directly positioned on the element or one or more centered elements may be present therebetween. When an element is defined as “being connected or coupled to” another element, the element may be directly connected or coupled to the element or one or more centered elements may be present therebetween. In the description of the present disclosure, it should be understood that the terms “up”, “down”, “inner”, “outer”, “bottom”, “vertical”, “horizontal”, and the like indicate orientations and position relationships which are based on the illustrations in the accompanying drawings, and these terms are merely for ease and brevity of the description, instead of indicating or implying that the devices or elements shall have a particular orientation and shall be structured and operated based on the particular orientation. Accordingly, these terms shall not be construed as limiting the present disclosure. In addition, the terms “first”, “second”, and the like are merely for the illustration purpose, and shall not be construed as indicating or implying a relative importance.

Unless the context clearly requires otherwise, throughout the specification and the claims, technical and scientific terms used herein denote the meaning as commonly understood by a person skilled in the art. Additionally, the terms used in the specification of the present disclosure are merely for describing the objectives of the specific embodiments, and are not intended to limit the present disclosure. As used herein, the term “and/or” in reference to a list of one or more items covers all of the following interpretations of the term: any of the items in the list, all of the items in the list and any combination of the items in the list.

In addition, technical features involved in various embodiments of the present disclosure described hereinafter may be combined as long as these technical features are not in conflict.

An embodiment of the present disclosure provides a lens focus adjustment assembly 100. Referring to FIG. 1 to FIG. 3, the lens focus adjustment assembly 100 mainly includes a barrel 10, a focus adjustment ring 20, and a motion assembly 30. The focus adjustment ring 20 and the motion assembly 30 are both mounted on the barrel 10. The focus adjustment ring 20 is configured to rotate on the barrel 10 to cause the motion assembly 30 to move back and forth with respect to the barrel 10, such that a position of a lens in the motion assembly 30 is adjusted.

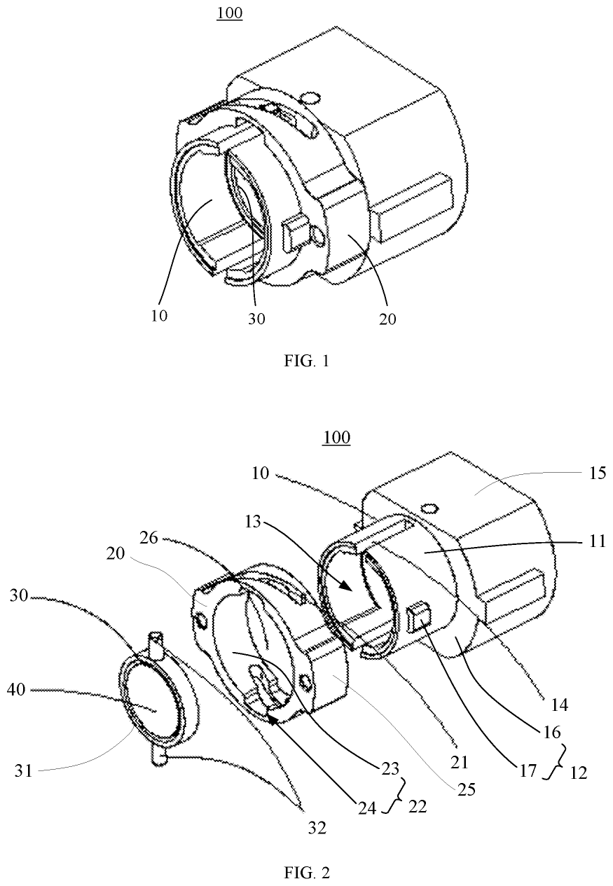

As illustrated in FIG. 2, the barrel 10 includes a barrel body 11 and a limiting structure 12, wherein the barrel body 11 defines a receiving space 13, and the barrel body 11 is provided with a channel 14. The barrel 10 is configured to receive a lens, and provide a passage for light to pass through. The barrel body 11 is in a tubular shape, for example, a cylindrical shape. The barrel body 11 defines, via a tubular side wall, the receiving space 13. The channel 14 may run through the tubular side wall of the barrel body 11 in a thickness direction, and run through one end, for example, toward the light emitting direction, of the barrel body 11 in a length direction.

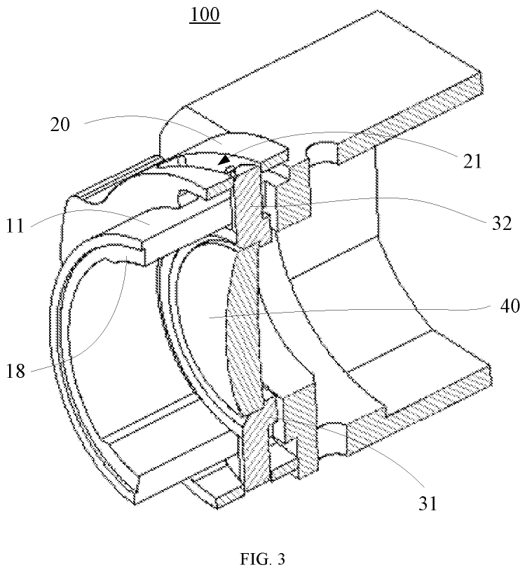

Referring to FIG. 2 and FIG. 3, the focus adjustment ring 20 is sleeved onto the barrel body 11 and rotatable about the barrel body 11. The focus adjustment ring 20 is provided with a groove 21, wherein the groove 21 is disposed approximately along a helix. In the case that the focus adjustment ring 20 is sleeved onto the barrel body 11, the limiting structure 12 may prevent the focus adjustment ring 20 from moving along an axial line of the barrel body 11. The focus adjustment ring 20 is an annular body, which encloses an internal space 26. The internal space 26 is configured to allow the barrel body 11 to be inserted therein. The groove 21 is opened on a side wall of the focus adjustment ring 20, may be a channel running through the side wall of the focus adjustment ring 20, or may be the groove recessed radially and outwardly from an inner side of the side wall of the focus adjustment ring 20. The groove 21 is an inclined groove, and the direction of the groove 21 is similar to that of a section of thread. For example, the groove 21 may cause a portion proximal to a first end surface of the focus adjustment ring 20 to extend in a circumferential direction and the axial direction at the same time, such that the groove 21 terminates at a portion proximal to a second end surface of the focus adjustment ring 20. Two ends of the groove 21 may each have a stop portion, such that the mating member 32 of the motion assembly 30 may only move between the two ends of the groove 21 without moving out of the groove 21.

The motion assembly 30 may include a support member 31 and a mating member 32. The support member 31 is configured to fix a lens 40, and the mating member 32 extends outwardly and radially from the support member 31 approximately. Upon assembling, the support member 31 and the lens 40 thereon are positioned in the receiving space 13 of the barrel body 11, and the mating member 32 runs through the channel 14 and mates with the groove 21. The motion assembly 30 may also be referred to as a motion spacer.

Where focus adjustment is needed, the focus adjustment ring 20 may be caused to rotate about the barrel body 11, such that the groove 21 mates with the mating member 32 and drives the mating member 32 to move back and forth along the channel 14, and the mating member 14 meanwhile drives the support member 31 to move along the axial line of the barrel body 11 in the receiving space 13. It is easy to understand that when rotating, the focus adjustment ring 20 may not move axially, a cam surface of the groove 21 drives the mating member 32 to move axially, such that the mating member 32 simultaneously drives the support member 31 and the lens 40 to move along the axial line of the barrel body 11.

In the lens focus adjustment assembly 100 as described in the above embodiment, the position of the lens 40 is adjusted by mating between the barrel 10, the focus adjustment ring 20, and motion assembly 30. Therefore, the lens focus adjustment assembly 100 has a simple structure, is easy to operate to implement debugging of a focal length, and occupies a small space. Therefore, the lens focus adjustment assembly 100 of the present disclosure is suitable for a projector, and particularly suitable for a portable projector, i.e., a micro-projector.

In some embodiments, the barrel 10 further includes a barrel fixing portion 15, wherein the barrel fixing portion 15 is configured to mount and fix the barrel 10, and the barrel body 11 is connected to an end surface 16 of the barrel fixing portion 15. The barrel fixing portion 15 includes a planar structure or a protrusive structure, such that other components in the projector easily mate with each other, the mounting and fixing of the barrel 10 are achieved, and the barrel 10 is prevented from moving. The limiting structure 12 includes the end surface 16 of the barrel fixing portion 15 and a stop 17 disposed on the barrel body 11, and the focus adjustment ring 20 is positioned between the end surface 16 of the barrel fixing portion 15 and the stop 17 of the barrel body 11. The barrel fixing portion 15 and the barrel body 11 may be integrally molded, or may be separately formed and then connected. The distance between the end surface 16 of the barrel fixing portion 15 and the stop 17 of the barrel body 11 may be equal to the thickness of the focus adjustment ring 20 in the axial direction, such that the focus adjustment ring 20 is prevented from moving back and forth, and the focus adjustment ring 20 is only allowed to rotate about the barrel body 11.

In some embodiments, the barrel body 11 may be in a cylinder, and the channel 14 may be parallel to the axial line of the barrel body 11. The cylindrical barrel body 11 is configured to provide an outer surface of the cylinder, so as to rotatably mate with a cylindrical inner surface portion of the focus adjustment ring 20. The channel 14 is disposed parallel to the axial line of the barrel body 11, and thus a linear passage is formed, such that the mating member 32 is guided to move linearly. In addition, two channels 14 are configured, and the two channels 14 are opened on two sides of the barrel body 11. For example, the two channels 14 may be disposed along a diameter direction of the barrel body 11, such that a force applied on the mating member 32 are balanced, and movement becomes smooth. In addition, a portion of the barrel body 11 where the channel 14 is disposed is an inward protrusion portion 18, such that the inward protrusion portion 18 slidably mates with the support member 31. For example, an inner surface of the inward protrusion portion 18 may be positioned within a cylindrical surface with a smaller diameter, other inner surfaces of the barrel body 11 may be positioned within the cylindrical surface with a larger diameter, and thus only the inner surface of the inward protrusion portion 18 slidably mates with a cylindrical outer surface of the support member 31, such that a friction between the support member 31 and barrel body 11 is reduced, and adjustment becomes easier.

In some embodiments, an inner orifice surface 22 of the focus adjustment ring 20 includes a first portion 23 rotatably mating with the barrel body 11 and a recess portion 24 recessed radially and outwardly from the first portion 23, wherein the recess portion 24 allows the stop 17 of the limiting structure 12 on the barrel body 11 to run through. With the configuration of the recess portion 24, the focus adjustment ring 20 may be easily assembled on the barrel 10. That is, during assembling, the recess portion 24 of the focus adjustment ring 20 may be axially aligned with the stop 17 of the barrel body 11, i.e., the focus adjustment ring 20 is axially pushed and sleeved on the barrel body 11. After that, as long as the recess portion 24 is not aligned with the stop 17, the focus adjustment ring 20 is prevented from falling off from the barrel body 11.

In some embodiments, the focus adjustment ring 20 may include a handle portion 25. The handle portion 25 may be held by a user with his fingers to rotate the focus adjustment ring 20. In addition, the groove 21 of the focus adjustment ring 20 may run through the side wall of the focus adjustment ring 20, such that the motion assembly 30 is easily assembled. For example, the support member 31 and the mating member 32 of the motion assembly 30 may be separate structures. During assembling, the support member 31 is inserted into the barrel body 11, and then the mating member 32 is sequentially inserted through the groove 21 and the channel 14, and connected to the support member 31. In addition, two grooves 21 are configured in the focus adjustment ring 20, and the two grooves 21 are opened on two sides of the focus adjustment ring 20. For example, the two grooves 21 may be evenly distributed in the focus adjustment ring 20, such that a force applied on the mating member 32 are balanced, and movement becomes smooth.

In some embodiments, the support member 31 is in an annular shape, and the mating member 32 is a cylinder. The annular support member 31 may provide a cylindrical outer surface, and the cylindrical outer surface of the support member 31 slidably mates with the inward protrusion portion 18. The mating member is the cylinder, which may reduce the friction between the channel 14 and the side wall of the groove 21, and make adjustment easier.

In some embodiments, two mating members 32 are configured, and the two mating members 32 are disposed on two sides of the support member 31. For example, two mating members 32 may be symmetrically distributed on the support member 31, such that a force applied on the mating member 32 are balanced, and movement becomes smooth.

In some embodiments, at least one lens 40 is fixed in the support member 31. For example, one or a group of lenses are disposed inside the support member 31, and these lenses 40 may be integral with the support member 31.

In addition, the focus adjustment ring 20 is clearance-fitted to the barrel 11, the support member 31 is clearance-fitted to the barrel 11, and the mating member 32 is clearance-fitted to the groove 21. In the present disclosure, clearance-fitting refers to fitting having a clearance, and includes the case where the minimum clearance is equal to zero.

In some embodiments, a projector is further provided. The projector may include the lens focus adjustment assembly 100 as described above.

The projector may be any projector where the lens needs to be adjusted and moved. In particular, the projector may be the portable projector. Since the lens focus adjustment assembly 100 according to the present disclosure has the advantages of simple structure, convenient debugging, small temporary space, and the like, the lens focus adjustment assembly 100 is extremely suitable for the portable projector, that is, the micro-projector.

Described above are exemplary embodiments of the present disclosure, but are not intended to limit the scope of the present disclosure. Any equivalent structure or equivalent process variation made based on the specification and drawings of the present disclosure, which is directly or indirectly applied in other related technical fields, fall within the scope of the present disclosure.

1. A lens focus adjustment assembly, comprising:
a barrel, comprising a barrel body and a limiting structure, wherein the barrel body defines a receiving space, and the barrel body is provided with a channel;
a focus adjustment ring, sleeved onto the barrel body and rotatable about the barrel body, wherein the focus adjustment ring is provided with a groove disposed along a helix, and the limiting structure prevents the focus adjustment ring from moving along an axial line of the barrel body; and
a motion assembly, comprising a support member and a mating member, wherein the support member is configured to fix a lens and positioned in the receiving space, and the mating member extends from the support member and runs through the channel and mates with the groove;
wherein when the focus adjustment ring rotates about the barrel body, the groove mates with the mating member and drives the mating member to move back and forth along the channel, and the mating member meanwhile drives the support member to move along the axial line of the barrel body in the receiving space.

2. The lens focus adjustment assembly according to claim 1, wherein
the barrel further comprises a barrel fixing portion, the barrel fixing portion is configured to mount and fix the barrel, and the barrel body is connected to an end surface of the barrel fixing portion; and
the limiting structure comprises the end surface of the barrel fixing portion and a stop disposed on the barrel body, and the focus adjustment ring is positioned between the end surface of the barrel fixing portion and the stop of the barrel body.

3. The lens focus adjustment assembly according to claim 1, wherein
the barrel body is a cylinder, and the channel is parallel to the axial line of the barrel body; and/or
two channels are configured, and the two channels are opened on two sides of the barrel body; and/or
a portion of the barrel body where the channel is disposed is an inward protrusion portion, such that the inward protrusion portion slidably mates with the support member.

4. The lens focus adjustment assembly according to claim 1, wherein an inner orifice surface of the focus adjustment ring comprises a first portion rotatably mating with the barrel body and a recess portion recessed radially and outwardly from the first portion, wherein the recess portion allows a stop of the limiting structure on the barrel body to run through.

5. The lens focus adjustment assembly according to claim 1, wherein
the focus adjustment ring comprises a handle portion; and/or
the groove of the focus adjustment ring runs through a side wall of the focus adjustment ring; and/or
two grooves are configured in the focus adjustment ring, and the two grooves are opened on two sides of the focus adjustment ring.

6. The lens focus adjustment assembly according to claim 1, wherein the support member is in an annular shape, and the mating member is a cylinder.

7. The lens focus adjustment assembly according to claim 1, wherein two mating members are configured, and the two mating members are disposed on two sides of the support member.

8. The lens focus adjustment assembly according to claim 1, wherein
at least one lens is fixed in the support member; and/or
the focus adjustment ring is clearance-fitted to the barrel body, the support member is clearance-fitted to the barrel body, and the mating member is clearance-fitted to the groove.

9. A projector, comprising a lens focus adjustment assembly; wherein the lens focus adjustment assembly comprises:
a barrel, comprising a barrel body and a limiting structure, wherein the barrel body defines a receiving space, and the barrel body is provided with a channel;
a focus adjustment ring, sleeved onto the barrel body and rotatable about the barrel body, wherein the focus adjustment ring is provided with a groove disposed along a helix, and the limiting structure prevents the focus adjustment ring from moving along an axial line of the barrel body; and
a motion assembly, comprising a support member and a mating member, wherein the support member is configured to fix a lens and positioned in the receiving space, and the mating member extends from the support member and runs through the channel and mates with the groove;
wherein when the focus adjustment ring rotates about the barrel body, the groove mates with the mating member and drives the mating member to move back and forth along the channel, and the mating member meanwhile drives the support member to move along the axial line of the barrel body in the receiving space.

10. The projector according to claim 9, wherein the projector is a portable projector.

11. The projector according to claim 9, wherein
the barrel further comprises a barrel fixing portion, the barrel fixing portion is configured to mount and fix the barrel, and the barrel body is connected to an end surface of the barrel fixing portion; and
the limiting structure comprises the end surface of the barrel fixing portion and a stop disposed on the barrel body, and the focus adjustment ring is positioned between the end surface of the barrel fixing portion and the stop of the barrel body.

12. The projector according to claim 9, wherein
the barrel body is a cylinder, and the channel is parallel to the axial line of the barrel body; and/or
two channels are configured, and the two channels are opened on two sides of the barrel body; and/or
a portion of the barrel body where the channel is disposed is an inward protrusion portion, such that the inward protrusion portion slidably mates with the support member.

13. The projector according to claim 9, wherein an inner orifice surface of the focus adjustment ring comprises a first portion rotatably mating with the barrel body and a recess portion recessed radially and outwardly from the first portion, wherein the recess portion allows a stop of the limiting structure on the barrel body to run through.

14. The projector according to claim 9, wherein
the focus adjustment ring comprises a handle portion; and/or
the groove of the focus adjustment ring runs through a side wall of the focus adjustment ring; and/or
two grooves are configured in the focus adjustment ring, and the two grooves are opened on two sides of the focus adjustment ring.

15. The projector according to claim 9, wherein the support member is in an annular shape, and the mating member is a cylinder.

16. The projector according to claim 9, wherein two mating members are configured, and the two mating members are disposed on two sides of the support member.

17. The projector according to claim 9, wherein
at least one lens is fixed in the support member; and/or
the focus adjustment ring is clearance-fitted to the barrel body, the support member is clearance-fitted to the barrel body, and the mating member is clearance-fitted to the groove.
